(19) United States
(12) Patent Application Publication
(10) Pub. No.: US 2003/0056373 A1
(43) Pub. Date: Mar. 27, 2003

(54) Interchangeable head carving tool

(76) Inventor: Mark Anthony Loser, Peshtigo, WI (US)

Correspondence Address: Mark A. Loser, W-4904 Town Hall Rd., Peshtigo, WI, 54157-9583, US

(21) Appl. No.: 10/107,114

(22) Filed: Mar. 28, 2002

Related U.S. Application Data
(60) Provisional application No. 60/324,107, filed on Sep. 21, 2001.

(51) Int. Cl. B25D 3/00; B26B 5/00

(52) U.S. Cl. 30/168; 30/167

(57) ABSTRACT

An interchangeable head carving tool in which a selected concave hemispherical cutting head is detachably secured to a base member and a handle by a screw, thus securing all parts positively and thereby providing a means of swinging the tool similarity to an ax or hammer and utilizing the kinetic energy released into materials through a 360 degree cutting edge to perform carving and cutting operations.

### CROSS REFERENCE TO RELATED APPLICATIONS

This application claims the benefit of U.S. Provisional Patent Application Ser. No. 60/324,107 filed Sep. 21, 2001.

### STATEMENT REGARDING FEDERALLY SPONSORED RESEARCH OR DEVELOPMENT

“Not applicable”

### REFERENCE TO A SEQUENCE LISTING, A TABLE, OR A COMPUTER PROGRAM LISTING COMPACT DISC APPENDIX

“Not applicable”

### BACKGROUND OF THE INVENTION

The object of my present invention involves novel improvements in carving and cutting tools which greatly increase material removal rates, ease difficult contouring operations, extend tool cutting edge life and allow simplified sharpening of the tool cutting edge by anyone with average skills, these properties being heretofore inadequate.

Conventional carving and cutting tools require the brute force of the operator to push and guide tools through materials, thereby minimizing material removal rates and straining operator. Conventional carving and cutting tools tend to dull often due to their minimal cutting edge length. Conventional carving and cutting tools have difficulty in producing pockets, cavities and depressions with rounded corners. Conventional carving and cutting tools tend to jam or get stuck in materials due to their cutting edge geometry.Another drawback of conventional carving and cutting tools exists with the difficulty in restoring the cutting edge to an adequate sharpness, which can require expensive equipment and is difficult and frustrating.

### BREIF SUMMARY OF THE INVENTION

To an understanding of the nature of my invention and its basic distinctions from the carving and cutting tools of common use, it is nessessary to explain some principles and properties upon which my tool is designed.

My invention utililizes the concept of kinetic energy, whereby the mass of the tool in motion effects a great material removal rate compared to conventional carving and cutting tools, and imposes minimal strain to the operator, in simple terms, an ax or hammer type swing is used.

By having a choice of many various diameters and weights of interchangeable cuttings heads, an owner can attain a wide range of material removal rates, and also create many different contours with corner radii equal to radius of selected cutting head.

My tool incorporates a cutting head with an convex radius outside shape which acts as a depth control device, thereby guiding the cutting edge into, through and out of materials during the cutting process, which reduces jamming of said tool in work.

My tool has a concave hemispherical cutting head which allows the use of 360 degrees of the cutting head edge, thereby extending cutting edge life and providing unique opportunities such as producing pockets, depressions and cavities with rounded corners.

The inside of said cutting head, which is a concave hemispherical shape, provides a 180 degree arc contour for chips to follow during cutting, thereby expelling chips efficiently from the interior of said cutting head.

By pushing or pulling said tool across materials using a scraping motion, one can produce various groove contours while also achieving good material removal rates.

Another advantage of my invention is a very simple means of restoring the cutting edge sharpness by utilizing an appropriate arbor to mount said cutting head to a drill motor, then rotating said cutting head while bringing into contact with abrasive cloth or paper tangent to inner and outer cutting edge faces, thereby restoring the cutting edge to an adequate sharpness.

### BREIF DESCRIPTION OF THE SEVERAL VIEWS OF THE DRAWING

FIG. 1 is a perspective view of the Interchangeable Head Carving Tool

FIG. 2 is a fragmentary exploded perspective view of the tool system and showing four interchangeable cutting heads, (1a, 1b, 1c and 1d), of various diameter and weight.

FIG. 3 is a fragmentary elevation cross section view of the Interchangeable Head Carving Tool

FIG. 4 is an elevation cross section view of the cutting head.

FIG. 5 is an elevation cross section view of a cutting head with a beveled outside contour.

### DETAILED DESCRIPTION OF THE INVENTION

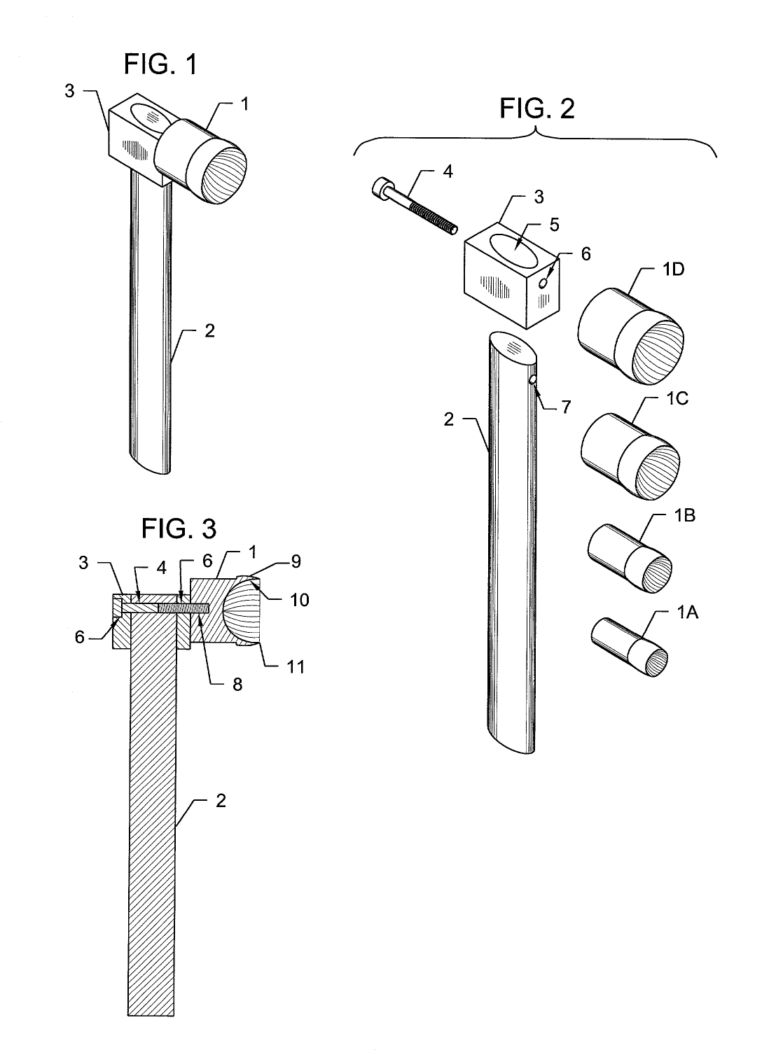

The tool as shown in FIGS. 1 and 3 is comprised of a base member 3, a handle 2, an interchangeable cutting head 1 and a screw 4.

The base member 3, is machined from a metal billet, forged from metal, or cast from metal and has an oval hole 5 through it for insertion of a handle. A counterbored screw hole 6 is drilled through said base member 3 perpendicular to said oval hole 5, and a lateral hole 7 is drilled through said handle 2 to align with said counterbored screw hole 6. Said screw 4 passes through said counterbored screw hole 6, then through said lateral hole 7, then threadably engages female threads 8 of said cutting head 1, thereby securing said base member 3, said handle 2 and said cutting head 1 positively together as the Interchangeable Head Carving Tool.

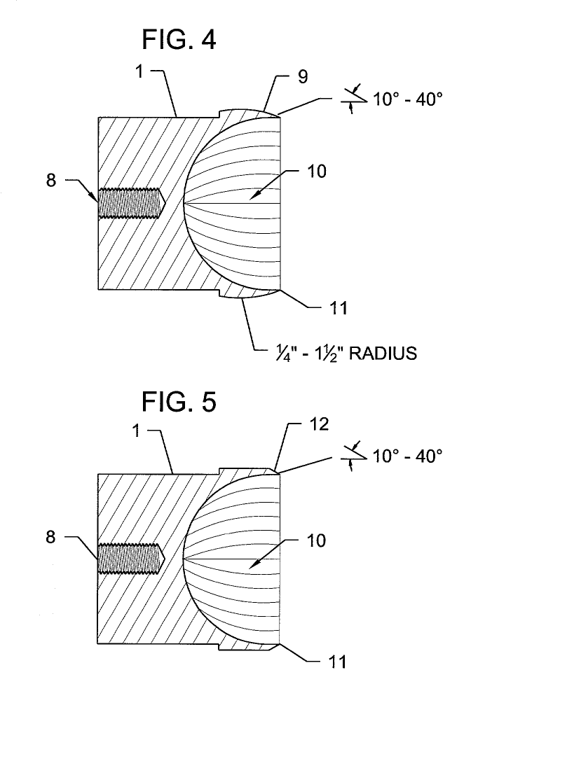

Said cutting head 1 is machined from a solid cylinder of metal, or a forging. During the machining process, female threads 8 are tapped concentrically into body of said cutting head 1 as shown in FIGS. 4 and 5, a convex radius outside shape 9 is produced as shown in FIGS. 3 and 4, and a concave hemispherical inside shape 10 is produced as shown in FIGS. 3 and 4. A 360 degree sharp cutting edge 11 is located where said convex radius outside shape 9 and said concave hemispherical inside shape 10 meet tangentially as shown in FIGS. 3 and 4. Said cutting head 1 is then heat treated and tempered to an adequate hardness, thereby providing a strong cutting edge with good wear resistance.

The tool system shown in FIG. 2 shows interchangeable cutting heads of four various diameters and weights, (1a, 1b, 1c and 1d), of which a multiplicity of diameters and weights is possible.

FIG. 5 shows a cutting head variation having a beveled outside contour 12, which simplifies the manufacturing process, but reduces the performance of said cutting head 1.

The Interchangeable Head Carving Tool FIG. 1 is used to carve, cut, or remove materials including, but not limited to, wood, ice, or plastics. The owner simply choses which diameter cutting head, (1a, 1b, 1c, or 1d) as shown in FIG. 2, is appropriate for a particular job, and attaches it to said base member 3 by means of said screw 4. By using a swinging motion, such as with an ax or hammer, the owner then repeatedly strikes the material being carved incrementally deeper with each successive swing until ones objective is met.

By pushing or pulling said Interchangeable Head Carving Tool FIG. 1 in a scraping motion across a material, many unique grooves can be produced, and good material removal rates can be achieved.

While certain representative embodiments and details have been shown for the purpose of illustrating the invention, it will be apparent to those skilled in the art that various changes in form and detail may be made without departing from the spirit and scope of the invention as defined by the appended claims.

What I claim is:

1. An interchangeable head carving tool comprising:
a base member having an oval hole through its center vertically for fixation of a handle, a counterbored hole extending through it axially for insertion of a screw, a planar surface parallel to said oval hole and perpendicular to said counterbored hole for seating of a selected cutting head;
a cutting head having a base end and a working end, said working end having a convex radius outside contour, said convex radius outside contour beginning at an angle of between 10 and 40 degrees tangent to longitudinal axis of said cutting head, said convex radius outside contour ending at cylindrical base end, said convex radius outside contour ranging between ¼ and 1½ inch radius, said working end having a concave hemispherical inside contour, said working end having a 360 degree cutting edge face, said 360 degree cutting edge face located at a position where said concave hemispherical inside contour meets said convex radius outside contour tangentially, said base end being cylindrical, and said base end having concentric axial female threads;
an elongated handle with a lateral hole extending through it in a position lined up with said counterbored hole in said base member when said handle and said base member are assembled; and
a screw for detachably securing a selected cutting head to said base member, wherein said screw passes through said counterbored hole in said base member, then through said lateral hole in said handle and threadably engages said cutting head.

2. An interchangeable head carving tool as defined in claim 1, wherein said cutting head can be a multiplicity of diameters and weights.

3. A cutting head having a base end and a working end, said working end having a convex radius outside contour, said convex radius outside contour beginning at an angle of between 10 and 40 degrees tangent to longitudinal axis of said cutting head, said convex radius outside contour ending at cylindrical base end, said convex radius outside contour ranging between ¼ and 1½ inch radius, said working end having a concave hemispherical inside contour, said working end having a 360 degree cutting edge face, said 360 degree cutting edge face located at a position where said concave hemispherical inside contour meets said convex radius outside contour tangentially, said base end being cylindrical, and said base end having concentric axial female threads.

4. A cutting head as defined in claim 3, wherein said cutting head can be a mulitiplicity of diameters and weights.

5. An interchangeable head carving tool comprising:
a base member having an oval hole through its center vertically for fixation of a handle, a counterbored hole extending through it axially for insertion of a screw, a planar surface parallel to said oval hole, and perpendicular to said counterbored hole for seating of a selected cutting head;
a cutting head having a base end and a working end, said working end having a beveled outside contour, said beveled outside contour being at an angle of between 10 and 40 degrees tangent to longitudinal axis of said cutting head, said beveled outside contour connecting to cylindrical base end, said working end having a concave hemispherical inside contour, said working end having a 360 degree cutting edge face, said 360 degree cutting edge face located at a position where said concave hemispherical inside contour meets said beveled outside contour tangentially, said base end being cylindrical, and said base end having concentric axial female threads;
an elongated handle with a lateral hole extending through it in a position lined up with said counterbored hole in said base member when said handle and said base member are assembled; and a screw for detachably securing a selected cutting head to said base member, wherein said screw passes through said counterbored hole in said base member, then through said lateral hole in said handle and threadably engages said cutting head.

6. An interchangeable head carving tool as defined in claim 5, wherein said cutting head can be a multiplicity of diameters and weights.

7. A cutting head having a base end and a working end, said working end having a beveled outside contour, said beveled outside contour being at an angle of between 10 and 40 degrees tangent to longitudinal axis of said cutting head, said beveled outside contour connecting to cylindrical base end, said working end having a concave hemispherical inside contour, said working end having a 360 degree cutting edge face, said 360 degree cutting edge face located at a position where said concave hemispherical inside contour meets said beveled outside contour tangentially, said base end being cylindrical, and said base end having concentric axial female threads.

8. A cutting head as defined in claim 7, wherein said cutting head can be a multiplicity of diameters and weights.
